(19) United States
(12) Patent Application Publication
(10) Pub. No.: US 2024/0126526 A1
(43) Pub. Date: Apr. 18, 2024

(54) Building Reliable and Fast Container Images

(71) Applicant: International Business Machines Corporation, Armonk, NY (US)

(72) Inventors: Abhishek Malvankar, White Plains, NY (US); Alaa S. Youssef, Valhalla, NY (US); Chen Wang, Chappaqua, NY (US); Mariusz Sabath, Ridgefield, CT (US)

(21) Appl. No.: 17/965,904

(22) Filed: Oct. 14, 2022

(51) Int. Cl. G06F 8/61

(52) U.S. Cl. CPC G06F 8/63

(57) ABSTRACT

Mechanisms are provided for improving performance of container images. Container image chunks are generated from a container image file and input into one or more trained machine learning (ML) computer models, trained to classify container image chunks with regard to a plurality of container image performance characteristic classifications. For each container image chunk it is determined whether the a corresponding classification is negative, and in response to the classification being negative, an entry in a knowledge base having patterns of content matching content in the container image chunk is identified to determine one or more reasons for modification of the chunk specified in the entry. A notification output is generated specifying the container image chunks, their corresponding container image performance characteristic classifications, and the reasons for modification of the chunks.

### BACKGROUND

The present application relates generally to an improved data processing apparatus and method and more specifically to an improved computing tool and improved computing tool operations/functionality for building reliable and fast container images.

Containers are executable units of software in which application code is packaged, along with its libraries and dependencies, in common ways so that it can be run anywhere, whether it be on desktop, traditional IT, or the cloud. To do this, containers take advantage of a form of operating system (OS) virtualization in which features of the OS (in the case of the Linux kernel, namely the namespaces and cgroups primitives) are leveraged to both isolate processes and control the amount of processor, memory, and disk space that those processes have access to, Containers are small, fast, and portable because unlike a virtual machine, containers do not need to include a guest OS in every instance and can, instead, simply leverage the features and resources of the host OS. Containers first appeared decades ago with versions like FreeBSD Jails and AIX Workload Partitions, but most modern developers remember 2013 as the start of the modern container era with the introduction of Docker.

The primary advantage of containers, especially compared to a virtual machine, is providing a level of abstraction that makes them lightweight and portable. Containers are lightweight in that they share the machine OS kernel, eliminating the need for a full OS instance per application, and making container files small and easy on resources, Their smaller size, especially compared to virtual machines, means they can spin up quickly and better support cloud-native applications that scale horizontally. Containers are portable and platform independent in that they carry all their dependencies with them, meaning that software can be written once and then run without needing to be reconfigured across laptops, cloud, and on-premises computing environments.

Containers support modern development and architecture m that, due to a combination of their deployment portability/consistency across platforms and their small size, containers fit modern development and application patterns, such as DevOps, serverless, and microservices, that are built as regular code deployments in small increments, Containers also improve utilization in that, like virtual machines (VMs) before them, containers enable developers and operators to improve processor and memory utilization of physical machines. Where containers go even further is that because they also enable microservice architectures, application components can be deployed and scaled more granularly, which is an attractive alternative to having to scale up an entire monolithic application because a single component may be struggling.

Containers are becoming increasingly prominent, especially in cloud environments. Many organizations are even considering containers as a replacement for virtual machines (VMs) as the general purpose compute platform for their applications and workloads. However, for containers to be utilized, software needs to be designed and packaged differently through a process referred to as containerization. When containerizing an application, the process includes packaging an application with its relevant environment variables, configuration files, libraries, and software dependencies. The result is a container image that can then be run on a container platform to thereby instantiate a container. That is, the container image is a static file with executable code that can create a container on a computing system. A container image is immutable, meaning it cannot be changed, and can be deployed consistently in any environment. Container images include everything a container needs to run, i.e., the container engine, such as Docker or CoreOS, system libraries, utilities, configuration settings, and specific workloads that should run on the instantiated container. A container image is composed of layers, added on to a parent or base image, such that the layers make it possible to reuse components and configurations across images.

As companies began embracing containers, often as part of modern, cloud-native architectures, the simplicity of the individual container began colliding with the complexity of managing hundreds (or even thousands) of containers across a distributed computing environment. To address this challenge, container orchestration emerged as a way managing large volumes of containers throughout their lifecycle, including provisioning, redundancy, health monitoring, resource allocation, scaling and load balance, and moving between physical hosts.

While many container orchestration platforms, such as Apache Mesos, Nomad, and Docker Swarm, were created to help address these challenges, Kubernetes, an open source project introduced by Google in 2014, quickly became the most popular container orchestration platform, and it is the one the majority of the industry has standardized on. Kubemetes enables developers and operators to declare a desired state of their overall container environment through YAW, files, and then Kubernetes does all the hard work establishing and maintaining that state, with activities that include deploying a specified number of instances of a given application or workload, rebooting that application if it fails, load balancing, auto-scaling, zero downtime deployments and more.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for improving performance of container images. The method comprises extracting a set of container image chunks from a container image file, where each of the container image chunks represent a sequence of code in the container image file. The method further comprises inputting each container image chunk into one or more trained machine learning computer models, where each trained machine learning computer model classifies container image chunks, with regard to a plurality of container image performance characteristic classifications, into at least one corresponding container image performance characteristic classification. The method also comprises, for each container image chunk, in at least a subset of the container image chunks, performing the following operations: (1) determining whether the at least one corresponding container image performance characteristic classification is a negative classification; (2) in response to the at least one corresponding container image performance characteristic classification being a negative classification, identifying one or more entries in a knowledge base having patterns of content matching content in the container image chunk, to identify one or more reasons for modification of the chunk specified in the one or more entries; and (3) for the container image chunks having a negative classification, generating a notification output specifying the container image chunks, their corresponding container image performance characteristic classifications, and the reasons for modification of the chunk.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram illustrating the primary operational elements of a container image performance issue classification (CIPIC) computing tool in accordance with one illustrative embodiment;

FIGS. 2A and 2B are diagrams illustrating examples of parsing an input container file into chunks or sequences in accordance with one illustrative embodiment;

FIG. 3 is an example diagram of a training dataset in accordance with one illustrative embodiment;

FIG. 4 is a flowchart outlining an example operation for classifying an input container file with regard to one or more container image performance characteristics in accordance with one illustrative embodiment; and

FIG. 5 is an example diagram of a distributed data processing system environment in which aspects of the illustrative embodiments may be implemented and at least some of the computer code involved in performing the inventive methods may be executed.

### DETAILED DESCRIPTION

Many users, e.g., data scientists and the like, utilize container images to deploy applications in modern computing environments. As noted previously, when containerizing an application, the application is packaged with its relevant environment variables, configuration files, libraries, and software dependencies, such that the container image can then be run on a container orchestration platform, such as the Kubernetes container platform, to thereby instantiate a container and thus, the application, on a host computing system. While such containerization and deployment of container images provides a lightweight and portable solution for application deployment, such as in a distributed data processing environment in which there are many computing devices and potentially many instances of the container executing within this distributed data processing environment, there is no standard or guidelines for developers on how to build/write fast, reproducible, and reliable container images. A poorly written container image can cause non-reproducible problems in production (deployment and use by users) leading to outages (the application provided by the container not being accessible by the users).

Fast building of containers is important in shared development environments where multiple competing users submit container jobs. Ideally, a container build time should be less than the actual job computation time. Thus, if build files are not written correctly, and with containers often including many layers, e.g., hundreds of layers, being appended to the base image, this can lead to very high build times.

In addition, reproducibility is an important factor with container image builds in that if such container image builds are not reproducible, they will lead to regression for computationally expensive workloads. For example, container images are built from a requirements file and if that requirements file is not properly specified, then errors in the requirements file will lead to a non-reproducible image. Reliability and vulnerabilities are also important factors in development of container images. For example, it is undesirable to use libraries that are not approved by an organization and such unapproved libraries may represent vulnerabilities, i.e., software bugs or errors that a hacker may be able to use to exploit a container system. Moreover, unapproved libraries may have critical bugs or errors, such as memory leaks, thread hangs, etc., which could cause a deployed container to be unreliable.

Existing container registry systems, that provide storage and access to container images for use in application development, only provide some level of build file checking to identify outdated libraries, or to check for vulnerable container images. These checks merely present a query against a database to make sure that the library is one that is up to date and does not have known vulnerabilities. These container registry systems do not provide any mechanisms for identifying layers of a container image that lead to slowness (build time is equal to or greater than the build job computation time), non-reproducible, or non-reliable container image builds.

The illustrative embodiments provide an improved computing tool and improved computing tool operations/functionality that address challenges in the building of fast, reproducible, and reliable container images. For example, the illustrative embodiments provide mechanisms to identify portions of a container image builds that lead to issues, such as slow build time, non-reproducibility, or non-reliability of the container image build. It should be appreciated that the term “build” is used herein to reference the fact that the container image may still be in development while the improved computing tool and improved computing tool operations/functionality are operating on the container image. However, the illustrative embodiments may also be applied to already built container images, such as those already stored in a container registry, to evaluate these container images with regard to speed, reproducibility, and reliability, among other potential container image issues.

The illustrative embodiments provide mechanisms to detect issues of container image builds such that the developers can modify or “fix” the build files to improve speed, reproducibility, and reliability of the resulting container image. The illustrative embodiments provide mechanisms that are able to identify multiple causes of such issues within container image files, or builds, and notify users if it is determined that a container image causes such issues.

With the mechanisms of the illustrative embodiments, a container image file, such as a Dockerfile or the like, is converted into a plurality of “chunks”, or portions, of the file based on a given domain knowledge of the programming language used to construct the container image file. The conversion of the container image file into chunks may be performed using a file parser and a natural language processing computer model that is trained and utilizes an input vocabulary database for the particular programming language, so that it is able to identify various portions of the language defining the container image in the container image file. Each chunk is modeled as a sequence and the chunks themselves may be represented as a sequence of chunks.

The chunks are input to one or more trained machine learning computer models which classify the sequences of the chunks as to whether the chunk is likely to cause the container image to have a slow build time, a reproducibility issue, or a reliability issue. These machine learning computer models may be trained on training datasets that have container image files and corresponding ground truth labels with regard classifications of slowness/fastness of build time, reproducibility, and reliability. The machine learning computer models are trained, through a supervised or unsupervised machine learning process involving multiple iterations or epochs, and the minimization of a loss or costs function until a convergence of the machine learning computer model is achieved, to recognize patterns of input data corresponding to these container image files and generate correct classifications with regard to these characteristics of container image file builds. In some cases, an ensemble of trained machine learning computer models may be utilized where each machine learning computer model may be separately trained with regard to one of these characteristics of container image file builds, e.g., one machine learning computer model classifies container image file builds with regard to slowness/fastness of the build time, a second machine learning computer model classifies image file builds with regard to reproducibility, and a third machine learning computer model classifies image file builds with regard to reliability. In some illustrative embodiments, a fourth machine learning computer model may be trained to classify image file builds with regard to vulnerabilities. In some illustrative embodiments, a single machine learning computer model may be trained to perform classification with regard to a plurality of these characteristics of container image file builds.

If one or more of the machine learning computer models generates a negative classification, i.e., an undesirable or unwanted characteristic classification, such as, for example, the container image build is slow, non-reproducible, non-reliable, etc., then the locations, e.g., the chunks or locations within sequences of the chunks, are recorded and a corresponding reason and/or suggested recommendation to modify/fix that location, as obtained from a knowledge base of domain knowledge, may be recorded. The knowledge base of domain knowledge may comprise a database of knowledge tuples that specify particular patterns of strings (text) represented in the content or sequences of a chunk, which are correlated with a reason for modification/fixing, and may include specific recommended resolution actions to take to make the corresponding pattern faster, more reproducible, or more reliable. By applying the knowledge base to the locations identified as being associated with issues in the container image build, matching tuples in the knowledge base may be identified and the corresponding reasons and recommendations may be identified and stored in association with the locations of these negative classifications.

The locations and corresponding recommendations/reasons for modification/fixing may be returned to the container image developer prior to the final build of the container image. This informs the developer of the potential issues of the container image build, the locations of these issues, and the recommendations regarding modifications/fixes to these locations. As a result, the developer may make appropriate modification/fixes to the container image build prior to the final build being generated and thereby improve the container image, which may then be built and stored in the container image registry.

In some illustrative embodiments, recommended actions identified by the application of the knowledge base to the locations associated with negative classifications may be automatically implemented by the development computing environment to thereby modify the container image file and generate an automatically modified container image file. The modified container image file is proposed as an improved container image file having improved speed, reproducibility, and/or reliability over the original container image file that was input for evaluation to the parser/NLP mechanisms and the trained machine learning computer model(s). The modified container image file may then be presented to the developers for verification of the modifications automatically made, which may be highlighted or otherwise conspicuously indicated in the presentation of the modified container image file, or may otherwise be sent to final build mechanisms for final build and registration with the container image registry.

Thus, the illustrative embodiments provide an improved computing tool and improved computing tool operations/functionality that specifically implements natural language processing logic specifically configured to the programming language used for the particular container images being evaluated, and one or more trained machine learning computer models that specifically are trained to evaluate and classify sequences, or chunks, within the container images with regard to container image performance characteristics, such as speed of build times, reproducibility, and reliability. Based on the classifications, locations within container images that may be associated with performance issues may be identified and matched to corresponding knowledge tuples in a domain specific knowledge base database that maps specific patterns of strings in the content of the sequences to reasons for modification/fix and/or recommendations as to remedial actions to take. This information may be output to developers, and/or may be used to automatically implement these modifications/fixes, so as to generate improved container image builds that provide improved performance and efficiency, such as with regard to build time, reproducibility, and reliability.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

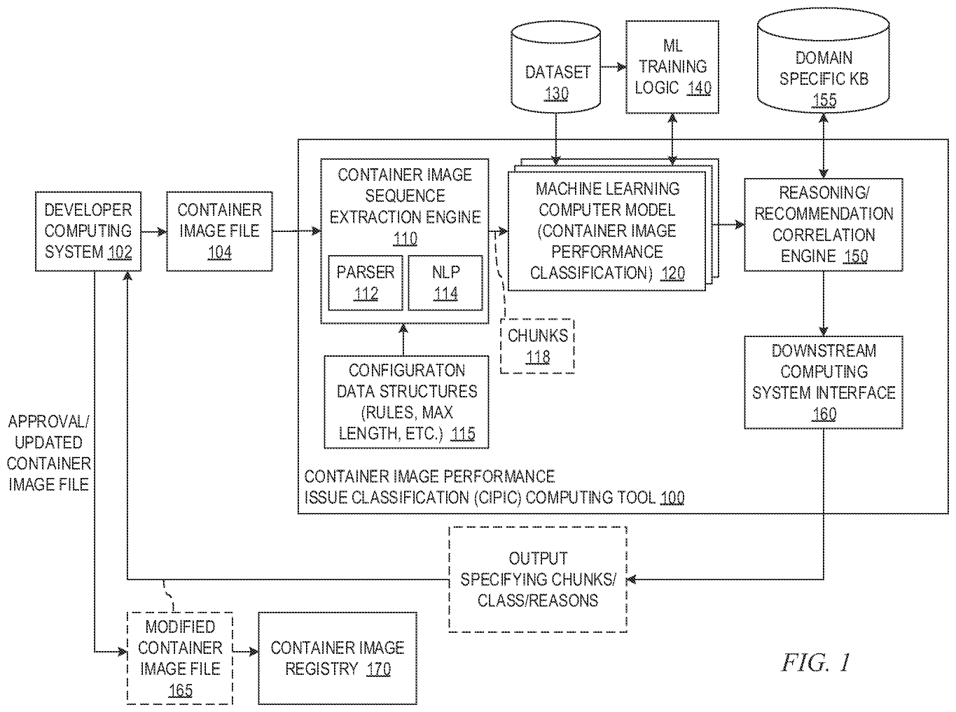

FIG. 1 is an example diagram illustrating the primary operational elements of a container image performance issue classification (CIPIC) computing tool in accordance with one illustrative embodiment. As shown in FIG. 1, the CIPIC computing tool 100, which may operate as part of one or more specifically configured computing systems, includes, as primary operational elements, a container image sequence, or chunk, extraction engine 110, one or more trained machine learning computer models 120, and a reasoning/recommendation correlation engine 150. In addition to these primary operational elements, the CIPIC computing tool 100 includes one or more configuration data structures 115 that are used to configure the parsers and natural language processing logic 112, 114 of the container image sequence extraction engine 110. The CIPIC computing tool 100 may also include, or operate in conjunction with, machine learning training logic 140 and training, testing, and validation datasets 130 that operate to train the one or more machine learning computer models 120 of the CIPIC computing tool 100. Moreover, the CIPIC computing tool 100 may include one or more domain specific knowledge base databases 155 that are used to perform lookup and matching operations by the reasoning/recommendation correlation engine 150 for identified locations of container image performance issues. In addition, the CIPIC computing tool 100 may include an downstream computing system interface 160 that generates outputs based on the correlations from the reasoning/recommendation correlation engine 150 to present the identified locations of performance issues in container image files, the reasons and recommendations for modification/fixes to these identified locations of performance issues, and/or performance of automated modification/fixing of the locations of performance issues to generate modified container image files which may then be presented to developers or other authorized personnel for verification and implementation in final builds of the container image files and registry in a container image registry 170.

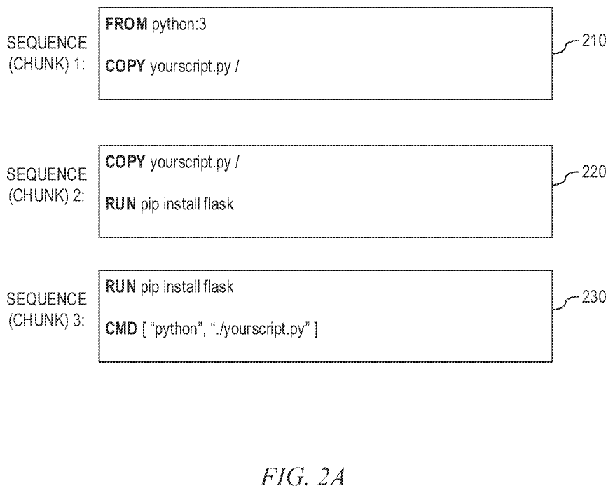

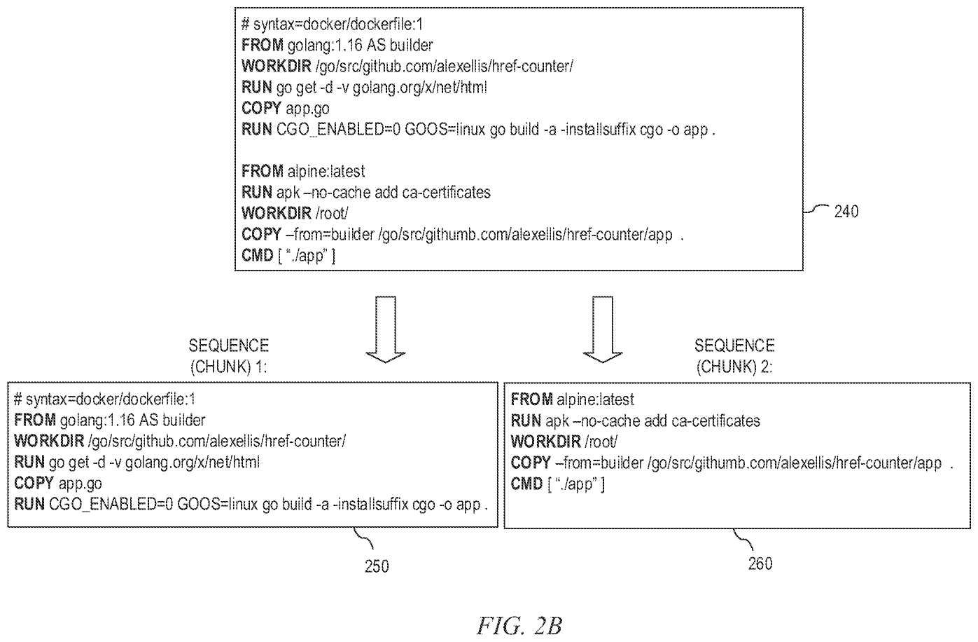

In the depiction of FIG. 1, a developer, via their developer computing system 102, may generate a container image file 104 for an application through a containerization process as previously described above. Container files and the containerization process are generally known in the art and are outlined above, and therefore are not further detailed herein. Suffice it to say, that the developer through this developer computing system 104 and development computing environment provides as input to the CIPIC computing tool 100, a container file 104. The container file 104, as outlined above, comprises code, written in a programming language, which can be executed to create a container on a computing system. The container images also includes everything a container needs to run, i.e. the container resources, such as the container engine, system libraries, utilities, configuration settings, and specific workloads that should run on the instantiated container. The code and container resources may be provided as layers added to a parent or base container image, such that the layers make it possible to reuse components and configurations across container images. Examples of portions of the code of a container image will be discussed hereafter with regard to FIGS. 2A-2B. One non-limiting example of a container image file 104 may be a Dockerfile, for example.

The container image sequence extraction engine 110 comprises a parser 112 and a natural language processing (NLP) engine 114 that operate to parse the container image file 104 and identify key terms/phrases within the container image file 104 indicative of specific sequences, or chunks, of the container image file 104. For example, the container image sequence extraction engine 110 may be trained for sentence boundary detection within container image files based on a domain knowledge and specific indicators that may be included in the container image file 104, e.g., “\n” may be used as a tag for special keywords, such as “FROM” and the like, for detecting new chunks in the container image file 104. The parser 112 and NLP engine 114 may be specifically configured for the particular programming language used to define the container image file 104 by the one or more configuration data structures 115 that specify domain knowledge for sequence identification and generation. This domain knowledge may include a programming language vocabulary for the particular programming language used to define the container image file, and the NLP engine 114 may comprise one or more NLP computer models that are trained on this vocabulary to identify and label portions of the input container image file 104 with regard to what portions of the vocabulary are present in the container image file 104. While this engine 114 is referred to as a natural language processing engine 114, it should be appreciated that the language is not a natural language, in the sense that the language is not a typically spoken language of human beings, but rather is a programmatic language and thus, while the NLP acronym is used to connote a similarity with natural language processing computing tools, the illustrative embodiments in fact are using a programmatic language processing engine, or PLP engine 114, but which implements operations, such as parsing and processing of language, that is similar in operation to natural language processing but specifically configured and adapted for programmatic language.

In one or more of the illustrative embodiments, the configuration data structures 115 may comprise a set of pre-defined rules that are implemented by the parser 112 and NLP engine 114 to identify key terms/phrases, in the corresponding programming language, that are indicative of particular sequences or chunks that the CIPIC computing tool 100 is to evaluate with regard to container image performance issues. These pre-defined rules may be of a type that specifies a triggering key term/phrase that indicates the beginning of a sequence or chunk within the programmatic language, and then also specifies criteria for defining the end of the sequence or chunk. These criteria may take many different forms, including other key terms/phrases that are indicative of an end point of the sequence or chunk, such as “FROM”, “COPY”, “RUN”, new line characters, etc., a number of lines of code to include in the sequence or chunk after the triggering term/phrase, or the like. In addition, the rules may specify limits on the chunks, such as a maximum size limit in terms of lines of code, number of characters or terms, or the like. For example, a rule may specify a triggering key term/phrase to be the term “FROM” and a sequence as the code (text) subsequent to the triggering key term/phrase “FROM” up to a maximum length, e.g., N words, where N is a configurable length. Similar triggering terms/phrases, such as “COPY”, “RUN”, and the like, may also be specified in similar rules with the same or different sequence or chunk end conditions.

The parser 112 and NLP engine 114 of the container image sequence extraction engine 110 operate on the input container image file 104 to break down the container image file 104 into sequences or chunks 118, where a chunk contains a sequence within the container image file 104 (hereafter referred to simply as “chunks”). The chunks 118 themselves may be provided as a sequence of chunks 118 for purposes of location of container image performance issues, as discussed hereafter. Thus, each chunk 118 is modeled as a sequence of text strings, and the chunks 118 themselves may be represented as a sequence of chunks 118.

The chunks 118 are input to one or more trained machine learning computer models 120 which classify the sequences of the chunks 118 as to whether the chunk 118 is likely to cause the container image of the container image file 104 to have a slow build time, a reproducibility issue, reliability issue, or a vulnerability issue. The one or more trained machine learning computer models 120 may operate on one or more chunks 118 at a time which are provided as input to the machine learning computer models 120. Thus, for example, each individual chunk 118, e.g., a first chunk, may be evaluated, and a portion of the sequence of chunks 118 may be evaluated, e.g., chunks 1-3, and then 3-5, and then 5-8, etc. In the case of a portion of a sequence of chunks 118, the portions may be overlapping to a predetermined allowable degree of overlap to account for patterns that may exist across the portions of the sequence of chunks. The machine learning computer model(s) 120 evaluate the input data, i.e., the one or more chunks 118, and look for patterns within the data, according to their training, that are indicative of one or more of a slow build time (build time that equals or exceeds a computation time), a reproducibility issue, or a reliability issue, or a combination of more than one of these issues.

These machine learning computer model(s) 120 may be trained, such as by machine learning training logic 140, on training datasets 130 that have container image files, or portions of container image files, such as specific sequences or chunks, or sequences of chunks, and corresponding ground truth labels with regard classifications of slowness/fastness of build time, reproducibility, and reliability. Similarly, a machine learning computer model may also be trained to identify particular sequences or chunks, or sequences of chunks, that represent a potential vulnerability in the container image file. The machine learning training logic 140 provides the necessary logic to train a machine learning computer model using a supervised or unsupervised machine learning process. This training may involve a stochastic gradient descent, linear regression, or any other known or later developed machine learning training operation to train the machine learning computer models to specifically receive one or more sequences or chunk(s) 118 of a container image file 104 and classify the input sequence(s) or chunk(s) 118 with regard to predetermined classes within the performance issue categories of build time efficiency (slowness/fastness of build time), reproducibility, reliability, and in some cases vulnerability. This machine learning training by the machine learning training logic 140 may comprise multiple iterations or epochs of processing of training input dataset(s) 130 to generate classifications, evaluating the correctness of those classifications by comparison to ground truth labels associated with the training dataset(s) to generate a loss or cost measure, and then making adjustments to operational parameters of the machine learning computer model(s) 120 to reduce or minimize the loss or costs function, until a convergence of the machine learning computer model training is achieved, i.e., the loss/cost is below a predetermined threshold value, a predetermined number of epochs have been executed, a predetermined minimum level of improvement of the loss/cost function is not able to be achieved, or the like. In this way, the machine learning training computer model(s) 120 are trained by the training datasets 130 and the training logic 140 to recognize patterns of input data, i.e., patterns in the content of the sequences or chunks 118, that correspond to particular classifications.

In some illustrative embodiments, the machine learning computer model(s) 120 may output a binary classification for each sequence/chunk 118 or a sequence of chunks 118, indicating a classification of the input as to whether it has or does not have a particular performance issue, e.g., a build time issue, a reproducibility issue, a reliability issue, or in some cases a vulnerability issue. In other illustrative embodiments, the output may be a vector output in which slots of the vector output correspond to different ones of the predetermined classifications and the values in each vector slot may specify a confidence or probability that the corresponding classification applies to or is the correct classification for that input. In some cases, an ensemble of trained machine learning computer models 120 may be utilized where each machine learning computer model 120 may be separately trained with regard to one of these characteristics of container image file builds, e.g., one machine learning computer model classifies container image file builds with regard to slowness/fastness of the build time, a second machine learning computer model classifies image file builds with regard to reproducibility, and a third machine learning computer model classifies image file builds with regard to reliability, etc.

The one or more trained machine learning computer models 120 may generate classification outputs that are provided to the reasoning/recommendation correlation engine 150. The reasoning/recommendation correlation engine 150 evaluates the classifications and, based on the classifications, determines if one or more of the machine learning computer models 120 generates a negative classification, e.g., the container image build is slow, non-reproducible, non-reliable, etc. For the negative classifications, if any, the reasoning/recommendation correlation engine 150 performs a lookup operation and retrieval of entries in the domain specific knowledge base database 155 that correspond to the particular content of the particular sequence or chunk, i.e., the location, of the potential container image performance issue of the particular negative classification. That is, for those locations, e.g., the chunks or locations within sequences of the chunks, the extracted strings, text, or the like, of the location is compared to the patterns specified in the domain specific knowledge base database 155 to identify one or more matching entries, e.g., if the sequence has a “Run” key term followed by another “Run” key term, then it may be determined that a reason for modifying/fixing this sequence may be that sequential “Runs” can be combined and a recommended remedial action may be to modify the container image content so that the multiple sequential “Runs” may be replaced with a single Run. For example, a pattern of (string 1, string 2, reason, remedial action) may be defined for each recognized pattern in the domain specific knowledge base database 155, and the strings may be matched to the locations corresponding to negative classifications. Thus, for example, a tuple in the domain specific knowledge base database 155 may be of (Run, Run, “continuous run commands can be merged”, “merge run commands into single run”). Similarly, another example may be (“FROM python: 3”, “<blank>”, “python needs specific version”, “insert specific version in blank”). Other examples of potential reasons and recommendations will be apparent to those of ordinary skill in the art in view of the present description.

Thus, the machine learning computer models 120 operate on the input sequences or chunks to generate classifications with regard to container image performance issues and for the negative classifications, i.e., classifications corresponding to potential container image performance issues being present, the locations within the chunks may be specifically correlated with reasons and recommendations from the domain specific knowledge base database 155 based on a lookup and matching of the contents of the chunk and the patterns specified in entries of the domain specific knowledge base database 155. The correlations are used to associate with the locations the corresponding reasoning and recommendations which may be used to generate an output by the downstream computing system interface 160.

That is, the location of the negative classification, e.g., the chunk, portion of the sequence within the chunk, or the like is recorded and a corresponding reason and/or suggested recommendation to modify/fix that location, as obtained from a knowledge base 155 of domain knowledge, may be recorded in a corresponding data structure associated with the container image file 104. The locations and corresponding recommendations/reasons for modification/fixing may be returned to the container image developer computing system 102 prior to the final build of the container image. For example, the downstream computing system interface 160 may generate an output specifying the location, the corresponding classification, and the reasoning for the modification/fix to the container image file 102. In some illustrative embodiments, the output may also specify a recommended remedial action to be performed, as specified in the tuples of the domain specific knowledge base database 155. The output may highlight or otherwise conspicuously identify the locations in the code of the container image file, and may correlate with these locations the classification, reasoning, and recommended remedial action. This informs the developer of the potential issues of the container image file, the locations of these issues, and the recommendations regarding modifications/fixes to these locations. As a result, the developer may make appropriate modification/fixes to the container image build prior to the final build being generated and thereby improve the container image, which may then be built and stored in the container image registry.

In some illustrative embodiments, recommended remedial actions identified for the locations associated with negative classifications may be automatically implemented by the development computing system 102 or other computing system of the development computing environment, to thereby automatically modify the container image file 102 and generate an automatically modified container image file 165. The modified container image file 165 is proposed as an improved container image file having improved speed, reproducibility, and/or reliability over the original container image file 102 that was input for evaluation to the container image sequence extraction engine 110, and the trained machine learning computer model(s) 120. The modified container image file 165 may then be presented to the developers for verification of the modifications automatically made, which may be highlighted or otherwise conspicuously indicated in the presentation of the modified container image file 165 on the developer computing system 102, or may otherwise be sent to final build mechanisms for final build and registration with the container image registry 170.

As noted above, the container image sequence extraction engine 110 operates to parse an input container file 104 into chunks or sequences. FIGS. 2A and 2B are diagrams illustrating examples of parsing an input container file into chunks or sequences in accordance with one illustrative embodiment. Container image files may be quite large, e.g., 1 gigabyte or larger, as opposed to smaller image files in the range of megabytes, drive up storage requirements for running containers which often results in increase monetary costs to run containers in cloud computing environments, especially in situations where layered container image files are utilized and many layers may be generated and applied to a base container image. In some illustrative embodiments, the NLP engine 114 has a limited length, or sequence (chunk) size, that it is able to process and the machine learning computer models 120 may also have limitations on the size of the input that may be classified. Thus, the container image file 104 is broken down into sequences or chunks 118. This break down of the container image file 104 into chunks 118, in some illustrative embodiments, may break the container image file 104 into chunks corresponding to the maximum length able to be processed by these engines and models, with a predetermined amount of permittable overlap, e.g., N words of overlap where N is configurable.

FIG. 2A shows examples of sequences or chunks 210-230 that may be extracted from a container image file. As shown in FIG. 2A, the sequence comprises a listing of code from the container image file that contains a trigger term/phrase followed by a maximum length amount of content subsequent to this trigger term/phrase. Thus, for example, chunk 210 comprises the trigger term/phrase “FROM python 3” and is followed by a sequence of content from the container image file such that the sequence 210 has a maximum length, or is as close to the maximum length as possible without exceeding the maximum length. In the depicted example, there is a degree of overlap permitted of N words. For example, chunks 210 and 220 have common, or overlap, words of “COPY yourscript.py/” and chunks 220 and 230 have overlap words of “RUN pip install flask”. Container specific tokenization and sentence boundary identification performed by the mechanisms of the illustrative embodiments, split a large container image file into chunks/sequences.

FIG. 2B shows another example of sequences or chunks generated from an input container image file 240. As shown in FIG. 2B, the container image file 240 comprises a multistage build, and sequences or chunks may be associated with the key term/phrase “FROM” corresponding to each of the stages. It should be appreciated that within each sequence corresponding to “FROM” if that specific sequence is larger than the maximum length, the sequence may be further broken down into additional chunks/sequences, such as described previously, so as to ensure that the maximum length is not exceeded. Thus, for example, the container image file 240 may be broken down into chunks/sequences 250 and 260 via the tokenization and boundary identification mechanisms of the illustrative embodiments.

As noted above, the machine learning computer models 120 in FIG. 1 are trained to recognize patterns within chunks, sequences of chunks, and the like, and to classify those patterns as to whether they indicate an efficient container image file, or are indicative of a potential container image performance issue, such as an issue with build time, reproducibility, reliability, and in some cases vulnerabilities. In order to perform this training, a training dataset is utilized that has ground truth labels that specify the proper classification of the corresponding training data, for a plurality of examples. Thus, by inputting the training data to the machine learning computer model, and evaluating the correctness of the output classifications generated by the machine learning computer model, the operational parameters of the machine learning computer model may be modified to reduce error in the output results of the machine learning computer model and thereby improve the classifications performed by the machine learning computer model.

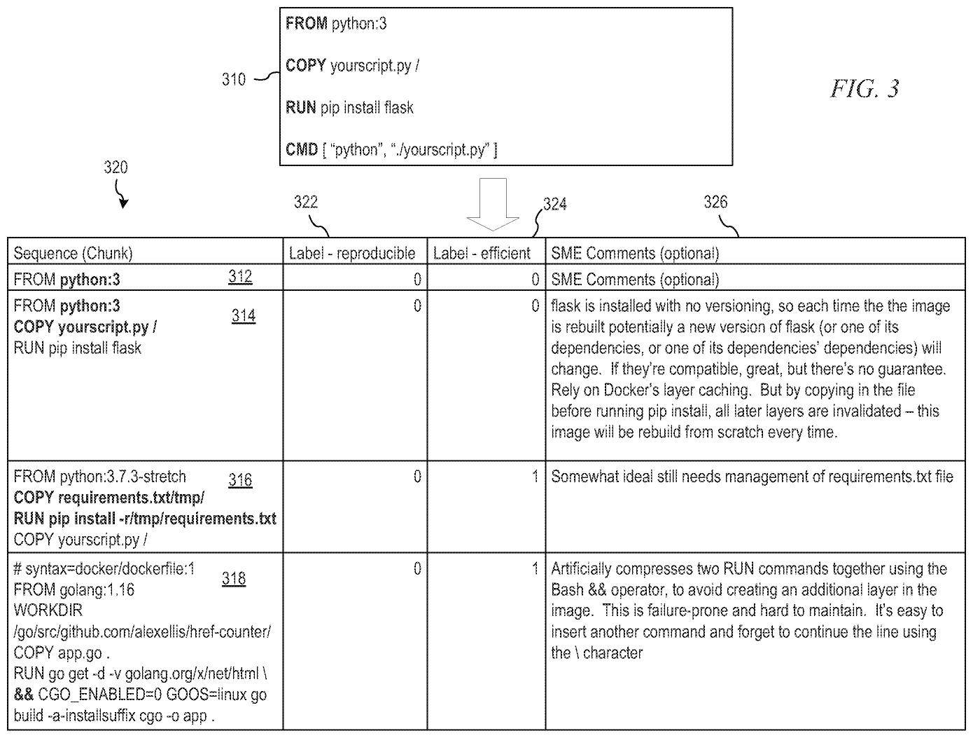

FIG. 3 is an example diagram of a training dataset in accordance with one illustrative embodiment. In the example of FIG. 3, 310 represents a training data example of a portion of a container image file. The element 320 represents a corresponding ground truth data structure 320 correlating snippets 312-318 of the portion of the container image file 310 with correct output labels of the snippet for both reproducibility and efficiency, where efficiency in this context may be considered a build time, where the build time is considered efficient if the build time is less than the compute time, as discussed previously.

As shown in FIG. 3, the portion of the container image file 310 has snippets 312-318 which correspond to entries in the ground truth data structure 320. Each entry has the sequence, or snippet, associated with a reproducibility ground truth label 322, an efficiency ground truth label 324, and a SME comment 326, which is optional to the illustrative embodiments but provides a reason why the snippet is considered to have the corresponding ground truth labels. In the example, each of the labels 322, 324 are a binary label where the label is set to 1 if the snippet of the container image file 310 is considered indicative of the container image file being efficient/reproducible, and is set to 0 if the snippet of the container image file is considered to be indicative of the container image file being not efficient or not reproducible. It should be appreciated that additional ground truth labels for reliability, vulnerability, and/or other container image performance characteristics may be included and corresponding machine learning computer models may be trained on this training data and ground truth labels.

With this training input, the machine learning computer model(s) 120 may receive the container image file 310 as training input data, classify the training input data, and the training logic may compare the machine learning computer model classification to the ground truth to determine an error, e.g., did the machine learning computer model 120 generate the correct label(s) or not. Based on the determined error, a stochastic gradient descent or other machine learning approach to modifying operational parameters of the machine learning computer model 120 may be implemented to modify the operational parameters to minimize the error. Thus, the machine learning computer models may be trained such that if they see the input pattern corresponding to the snippet, they will generate the correct label(s) with regard to the various container image performance characteristics, e.g., reproducibility, efficiency, reliability, vulnerability, etc.

It should be appreciated that FIG. 3 shows the training data for just one instance of a portion of a container image file 310. Similar data structures may be provided for many more container image files and/or portions of container image files. The training data used to train the machine learning computer models will include many hundreds of such examples that are used in the iterative process to perform the machine learning training of the models 120. After training the machine learning computer model(s) 120 using training data similar to that shown in FIG. 3, for example, the machine learning computer model(s) 120 are executed on input chunks or sequences of input container image files to thereby classify these new container image files with regard to the various one or more container image performance characteristics.

Thus, the illustrative embodiments provide an improved computing tool and improved computing tool operations/functionality that specifically implements natural language processing logic specifically configured to the programming language used for the particular container images being evaluated, and one or more trained machine learning computer models that specifically are trained to evaluate and classify sequences, or chunks, within the container images with regard to container image performance characteristics, such as speed of build times, reproducibility, and reliability. Based on the classifications, locations within container images that may be associated with performance issues may be identified and matched to corresponding knowledge tuples in a domain specific knowledge base database that maps specific patterns of strings in the content of the sequences to reasons for modification/fix and/or recommendations as to remedial actions to take. This information may be output to developers, and/or may be used to automatically implement these modifications/fixes, so as to generate improved container image builds that provide improved performance and efficiency, such as with regard to build time, reproducibility, and reliability.

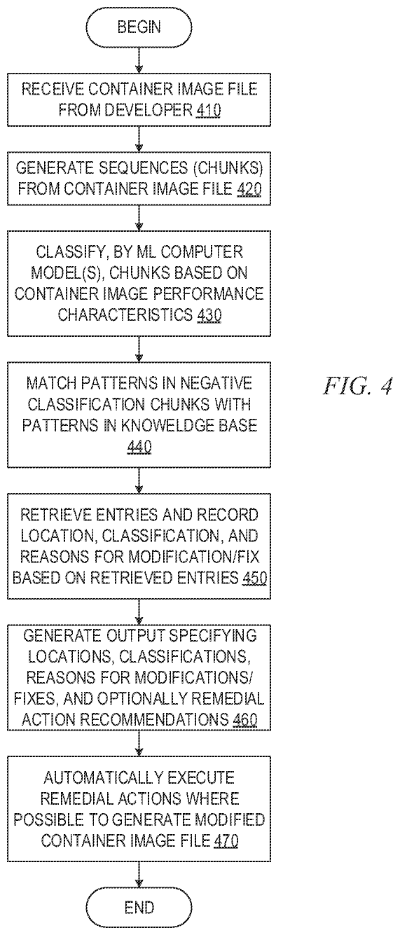

FIG. 4 provides a flowchart outlining an example operation of elements of the present invention with regard to one or more illustrative embodiments. It should be appreciated that the operations outlined in FIG. 4 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 4, and may, in some cases, make use of the results generated as a consequence of the operations set forth in FIG. 4, the operations in FIG. 4 themselves are specifically performed by the improved computing tool in an automated manner.

FIG. 4 is a flowchart outlining an example operation for classifying an input container file with regard to one or more container image performance characteristics in accordance with one illustrative embodiment. The operation outlined in FIG. 4 assumes a previous training of machine learning computer model(s) based on a training dataset, where each machine learning computer model is trained to classify sequences/chunks with regard to one or more container performance characteristics. For example, in one illustrative embodiment, there is a separate machine learning computer model trained to evaluate and classify sequences/chunks with regard to build time efficiency, reproducibility, reliability, and in some cases vulnerability. The operation further assumes a specifically configured natural language processing model that is specifically configured for the particular programming language of the container image file and implements a set of rules for identifying sequences/chunks in the container image file in accordance with one or more of the illustrative embodiments described above.

As shown in FIG. 4, the operation starts with a developer submitting a container image file for evaluation (step 410). The container image file is parsed and processed using natural language processing (NLP), or more accurately programming language processing (PLP), and predetermined domain knowledge rules for sequence generation, to thereby break the container image file into a plurality of sequences or chunks (step 420). The sequences or chunks are input to the trained machine learning (ML) computer model(s) which classify the chunks, sequences within chunks, and/or sequences of chunks, with regard to one or more container image performance characteristics (step 430). The classifications are output to a reasoning/recommendation correlation engine that performs a lookup and matching of entries in a domain specific knowledge base that have content patterns matching locations where negative classifications have been made (step 440). Based on the retrieved entries, the location of negative classifications, i.e., the chunks or sequences within the chunks where a negative classification was determined to be present, are recorded in association with a reason for modification/fixing as determined form the matching entry from the knowledge base, and optionally a recommended remedial action from the knowledge base (step 450). An output specifying the classifications for the chunks of the container image file, the associate reasoning for modifications/fixes if any, and the recommended remedial actions, if any, is generated and provided to the developer (step 460). In some cases, automated implementation of the recommended remedial actions may be performed to generate a modified container image file that may be presented to a developer for review and approval (step 470). The operation then terminates.

As described above, the illustrative embodiments of the present invention are specifically directed to an improved computing tool that automatically parses an input container image file, evaluates and classifies the sequences within the input container image file with regard to container image performance characteristics, and correlates any performance issues identified through this classification, with corresponding reasons for modification/fixing of the locations of these performance issues and recommended remedial actions. All of the functions of the illustrative embodiments as described herein are intended to be performed using automated processes without human intervention. While a human being, e.g., a container image developer, may initiate the operations set forth herein and may provide the container image input through developer tools and computer software, the illustrative embodiments of the present invention are not directed to actions performed by the human developer, but rather logic and functions performed specifically by the improved computing tool on the container image files. Moreover, even though the present invention may provide an output to a developer's computing system that ultimately assists human beings in developing efficient container images, the illustrative embodiments of the present invention are not directed to actions performed by the human being viewing the results of the processing performed by the improved computing tool of the present invention, but rather to the specific operations performed by the specific improved computing tool of the present invention which facilitates the evaluation of container image files, with regard to container image performance, in an improved manner and ultimately the generation of results that specifically locate sequences and portions of sequences within container image files that may cause container image performance issues and correlate these with reasoning and recommendations for modification/fixing, which assists the human developer. Thus, the illustrative embodiments are not organizing any human activity, but are in fact directed to the automated logic and functionality of an improved computing tool.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides container image performance issue classification (CIPIC) logic and machine learning computer models, as well as logic for applying knowledge represented in a knowledge base database to performance issues identified to thereby generate reasoning and recommendations for modifications/fixing of input container image files. The improved computing tool implements mechanism and functionality, such as the CIPIC computing tool, which cannot be practically performed by human beings either outside of, or with the assistance of, a technical environment, such as a mental process or the like. The improved computing tool provides a practical application of the methodology at least in that the improved computing tool is able to automatically identify container image performance issues through specific sequencing of container image files and application of specifically configured natural language processing of container image files, as well as classification of these sequences by trained machine learning computer models, and correlation of classified container image performance issues with reasoning/recommendations for modifications/fixes, which informs developers of areas within container image files that may need to be modified/fixed in order to achieve improved performance of the resulting container images.

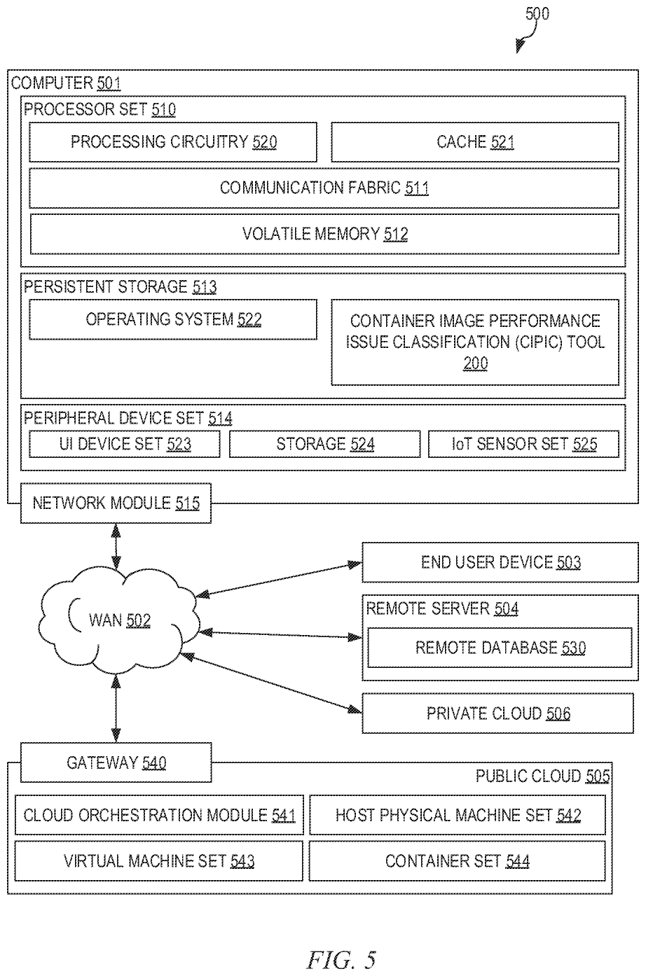

FIG. 5 is an example diagram of a distributed data processing system environment in which aspects of the illustrative embodiments may be implemented and at least some of the computer code involved in performing the inventive methods may be executed. That is, computing environment 500 contains an example of an environment for the execution of at least some of the computer code involved in performing the inventive methods, such as the container image performance issue classification (CIPIC) computing tool 100. In addition to block 100, i.e., the CIPIC computing tool 100, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 100, as identified above), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

Computer 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

Processor set 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 100 in persistent storage 513.

Communication fabric 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

Persistent storage 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface type operating systems that employ a kernel. The container image performance issue classification (CIPC) code included in block 100 typically includes at least some of the computer code involved in performing the inventive methods.

Peripheral device set 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

Network module 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

Remote server 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

Public cloud 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

As shown in FIG. 5, one or more of the computing devices, e.g., computer 501 or remote server 504, may be specifically configured to implement a CIPIC computing tool 100. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computing device 501 or remote server 504, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates identifying potential container image inefficiencies with regard to performance characteristics and identifying the particular locations of these inefficiencies and the reason for the need to modify/fix these locations, and potentially recommended remedial actions.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a communication bus, such as a system bus, for example. The memory elements can include local memory employed during actual execution of the program code, bulk storage, and cache memories which provide temporary storage of at least some program code in order to reduce the number of times code must be retrieved from bulk storage during execution. The memory may be of various types including, but not limited to, ROM, PROM, EPROM, EEPROM, DRAM, SRAM, Flash memory, solid state memory, and the like.

Input/output or I/O devices (including but not limited to keyboards, displays, pointing devices, etc.) can be coupled to the system either directly or through intervening wired or wireless I/O interfaces and/or controllers, or the like. I/O devices may take many different forms other than conventional keyboards, displays, pointing devices, and the like, such as for example communication devices coupled through wired or wireless connections including, but not limited to, smart phones, tablet computers, touch screen devices, voice recognition devices, and the like. Any known or later developed I/O device is intended to be within the scope of the illustrative embodiments.

Network adapters may also be coupled to the system to enable the data processing system to become coupled to other data processing systems or remote printers or storage devices through intervening private or public networks. Modems, cable modems and Ethernet cards are just a few of the currently available types of network adapters for wired communications. Wireless communication based network adapters may also be utilized including, but not limited to, 802.11 a/b/g/n wireless communication adapters, Bluetooth wireless adapters, and the like. Any known or later developed network adapters are intended to be within the spirit and scope of the present invention.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for improving performance of container images, the method comprising:
extracting a set of container image chunks from a container image file, wherein each of the container image chunks represent a sequence of code in the container image file;
inputting each container image chunk into one or more trained machine learning computer models, wherein each trained machine learning computer model classifies container image chunks, with regard to a plurality of container image performance characteristic classifications, into at least one corresponding container image performance characteristic classification; and
for each container image chunk, in at least a subset of the container image chunks:
determining whether the at least one corresponding container image performance characteristic classification is a negative classification;
in response to the at least one corresponding container image performance characteristic classification being a negative classification, identifying one or more entries in a knowledge base having patterns of content matching content in the container image chunk, to identify one or more reasons for modification of the chunk specified in the one or more entries; and
for the container image chunks having a negative classification, generating a notification output specifying the container image chunks, their corresponding container image performance characteristic classifications, and the reasons for modification of the chunk.

2. The method of claim 1, wherein extracting the set of container image chunks from a container image file comprises:
executing, on the container image file, a natural language processing computer model, trained on a vocabulary database corresponding to a programming language of the container image file, to identify boundary indicators in container image files, wherein the execution of the natural language processing computer model identifies a plurality of boundary indicators in the container image file; and
generating the set of container image chunks based on the identified boundary indicators in the container image file.

3. The method of claim 2, wherein the boundary indicators comprise at least one of key words, key phrases, or a predetermined chunk size.

4. The method of claim 2, wherein the natural language processing computer model is configured with a set of pre-defined rules that are implemented to identify key terms or key phrases in the programming language of the container image file as boundary indicators.

5. The method of claim 1, wherein the one or more trained machine learning computer models comprises an ensemble of a plurality of trained machine learning computer models, and wherein each machine learning computer model in the ensemble is trained to classify container image file chunks into a different one of the at least one corresponding container image performance characteristic classifications.

6. The method of claim 1, wherein the container image performance characteristic classifications comprise a build time classification, a reproducibility classification, and a reliability classification.

7. The method of claim 1, further comprising:
storing, for each container image chunk, a corresponding container image performance characteristic classification generated by the one or more trained machine learning computer models for the container image chunk, in a container image chunk data structure; and
storing, in association with container image chunks having a negative classification, a reason for modification of the chunk, based on the identified one or more entries from the knowledge base, in the container image chunk data structure, wherein the notification output is generated based on the container image chunk data structure.

8. The method of claim 1, further comprising:
generating, from the identified one or more entries in the knowledge base at least one recommendation for modifying the container image file; and
outputting the recommendation as part of the notification output.

9. The method of claim 8, further comprising, automatically executing the recommended modification to the container image file to generate a modified container image file.

10. The method of claim 1, wherein extracting the set of container image chunks comprises extracting the set of container image chunks such that each container image chunk has a measure of overlap of adjacent container image chunks in a sequence of container image chunks of the container image file.

11. A computer program product comprising a computer readable storage medium having a computer readable program stored therein, wherein the computer readable program, when executed on a data processing system, causes the data processing system to:
extract a set of container image chunks from a container image file, wherein each of the container image chunks represent a sequence of code in the container image file;
input each container image chunk into one or more trained machine learning computer models, wherein each trained machine learning computer model classifies container image chunks, with regard to a plurality of container image performance characteristic classifications, into at least one corresponding container image performance characteristic classification; and
for each container image chunk, in at least a subset of the container image chunks:
determine whether the at least one corresponding container image performance characteristic classification is a negative classification;
in response to the at least one corresponding container image performance characteristic classification being a negative classification, identify one or more entries in a knowledge base having patterns of content matching content in the container image chunk, to identify one or more reasons for modification of the chunk specified in the one or more entries; and
for the container image chunks having a negative classification, generate a notification output specifying the container image chunks, their corresponding container image performance characteristic classifications, and the reasons for modification of the chunk.

12. The computer program product of claim 11, wherein extracting the set of container image chunks from a container image file comprises:
executing, on the container image file, a natural language processing computer model, trained on a vocabulary database corresponding to a programming language of the container image file, to identify boundary indicators in container image files, wherein the execution of the natural language processing computer model identifies a plurality of boundary indicators in the container image file; and
generating the set of container image chunks based on the identified boundary indicators in the container image file.

13. The computer program product of claim 12, wherein the boundary indicators comprise at least one of key words, key phrases, or a predetermined chunk size.

14. The computer program product of claim 12, wherein the natural language processing computer model is configured with a set of pre-defined rules that are implemented to identify key terms or key phrases in the programming language of the container image file as boundary indicators.

15. The computer program product of claim 11, wherein the one or more trained machine learning computer models comprises an ensemble of a plurality of trained machine learning computer models, and wherein each machine learning computer model in the ensemble is trained to classify container image file chunks into a different one of the at least one corresponding container image performance characteristic classifications.

16. The computer program product of claim 11, wherein the container image performance characteristic classifications comprise a build time classification, a reproducibility classification, and a reliability classification.

17. The computer program product of claim 11, wherein the computer readable program further causes the data processing system to:
store, for each container image chunk, a corresponding container image performance characteristic classification generated by the one or more trained machine learning computer models for the container image chunk, in a container image chunk data structure; and
store, in association with container image chunks having a negative classification, a reason for modification of the chunk, based on the identified one or more entries from the knowledge base, in the container image chunk data structure, wherein the notification output is generated based on the container image chunk data structure.

18. The computer program product of claim 11, the computer readable program further causes the data processing system to:
generate, from the identified one or more entries in the knowledge base at least one recommendation for modifying the container image file; and
output the recommendation as part of the notification output.

19. The computer program product of claim 18, the computer readable program further causes the data processing system to automatically execute the recommended modification to the container image file to generate a modified container image file.

20. An apparatus comprising:
at least one processor; and
at least one memory coupled to the at least one processor, wherein the at least one memory comprises instructions which, when executed by the at least one processor, cause the at least one processor to:
extract a set of container image chunks from a container image file, wherein each of the container image chunks represent a sequence of code in the container image file;
input each container image chunk into one or more trained machine learning computer models, wherein each trained machine learning computer model classifies container image chunks, with regard to a plurality of container image performance characteristic classifications, into at least one corresponding container image performance characteristic classification; and
for each container image chunk, in at least a subset of the container image chunks:
determine whether the at least one corresponding container image performance characteristic classification is a negative classification;
in response to the at least one corresponding container image performance characteristic classification being a negative classification, identify one or more entries in a knowledge base having patterns of content matching content in the container image chunk, to identify one or more reasons for modification of the chunk specified in the one or more entries; and
for the container image chunks having a negative classification, generate a notification output specifying the container image chunks, their corresponding container image performance characteristic classifications, and the reasons for modification of the chunk.
